(19) United States
(12) Patent Application Publication
(10) Pub. No.: US 2005/0199599 A1
(43) Pub. Date: Sep. 15, 2005

(54) Method of fabrication of hermetically sealed glass package

(76) Inventors: Xinghua Li, Painted Post, NY (US); Sujanto Widjaja, Corning, NY (US)

Correspondence Address: William S. Francos;VOLENTINE FRANCOS, P.L.L.C., Suite 150, 12200 Sunrise Valley Drive, Reston, VA, 20191, US

(21) Appl. No.: 10/796,752

(22) Filed: Mar. 9, 2004

(51) Int. Cl. B23K 26/20; B23K 26/00

(52) U.S. Cl. 219/121.85

(57) ABSTRACT

A method of sealing an OLED structure includes providing a top glass substrate and a bottom glass substrate, and at least one layer of organic material between the glass substrates. The illustrative method also includes focusing a relatively high power, a relatively short-duration laser radiation onto a region of one glass substrate, thereby heating a focal volume through multiphoton absorption. The intense heat causes the interface of the glass to swell and bond onto the other glass substrate. An apparatus for sealing the structure and a sealed package are also disclosed.

### BACKGROUND

Organic light emitting devices/diodes (OLEDS) are often made from electroluminescent polymers and small-molecule structures. These devices have received a great deal of attention as alternatives to conventional light sources in displays as well as other applications. In particular, OLEDs in an array may provide an alternative to liquid crystal (LC) based displays, because the LC materials and structures tend to be more complicated in form and implementation.

One of the many benefits of OLED-based displays is that they do not require a light source (backlight) as needed in LC displays. To wit OLEDs are a self-contained light source, and as such are much more compact while remaining visible under a wider range of conditions. Moreover, unlike many LC displays, which rely on a fixed cell gap, OLED-based displays can be flexible.

While OLEDs provide a light source for display and other applications with at least the benefits referenced above, there are certain considerations and limitations that can reduce their practical implementation. For example, OLED materials are susceptible to environmental degradation. In particular, exposure of an OLED display to water vapor or oxygen or both, can be deleterious to the organic material and the structural components of the OLED. As to the former, the exposure to water vapor and oxygen can reduce the light emitting capability of the organic electroluminescent material itself. As to the latter, for example, exposure to these contaminants of reactive metal cathodes commonly used in OLED displays over time can over time result in ‘dark-spot’ areas and reduce the useful life of the OLED device. Accordingly, it is beneficial to protect OLED displays and their constituent components and materials from exposure to environmental contaminants such as water vapor and oxygen.

In order to minimize environmental contamination, OLEDs must be sealed between two layers, which are often glass substrates. In known structures, the glass substrates are sealed using epoxy adhesives. Other sealing techniques include the application of inorganic and organic materials that form a seal when exposed to ultraviolet radiation.

The referenced sealing methods have not provided the requisite sealing of OLED structures to allow their successful implementation. In particular, the known seals often allow moisture and oxygen to penetrate through to the organic layer and to the electrodes.

What is needed, therefore, is a method of sealing the glass substrates to form a hermetically sealed OLED structure that overcomes at least the shortcomings described above.

### SUMMARY

In accordance with an example embodiment, a method of sealing an OLED structure includes providing a top glass substrate and a bottom glass substrate, and at least one layer of organic material between the glass substrates. The illustrative method also includes focusing a relatively high power and relatively short-duration laser radiation onto a region of the top glass substrate.

In accordance with another example embodiment, an apparatus for sealing, includes a laser, and a controller, which controls the output power of the laser. The apparatus also includes an optical element that focuses light from the laser onto a top substrate and the substrate absorbs the light in a multiphoton absorption process, providing a hermetic seal between the top substrate and a bottom substrate.

In accordance with an example embodiment, an OLED package includes a top substrate and a bottom substrate; and a glass hermetic seal between the substrates, which provides a barrier to contaminants.

### BRIEF DESCRIPTION OF THE DRAWINGS

The exemplary embodiments are best understood from the following detailed description when read with the accompanying drawing figures. It is emphasized that the various features are not necessarily drawn to scale. The dimensions may be arbitrarily increased or decreased for clarity of discussion.

FIG. 1 is a cross-sectional view of the sealing of an OLED array between two substrates in accordance with an example embodiment.

FIG. 2 is a schematic block diagram of an apparatus for sealing an OLED array in accordance with an example embodiment.

FIG. 3 is a top view of an OLED showing a sealing about the perimeter in accordance with an example embodiment.

### DETAILED DESCRIPTION

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure that the present invention may be practiced in other embodiments that depart from the specific details disclosed herein. Moreover, descriptions of well-known devices, methods and materials may be omitted so as to not obscure the description of the present invention. Finally, wherever applicable like reference numerals refer to like elements.

In the example embodiments described herein, structures for OLED's are set forth in significant detail. It is noted, however, that this is merely an illustrative implementation of the invention. To wit, the example embodiments are applicable to other technologies that are susceptible to similar contamination problems as those discussed above. For example, embodiments in electronics and photonics are clearly within the purview of the present invention. These include, but are not limited to, integrated circuits and semiconductor structures.

Briefly, the example embodiments are drawn to a method of sealing at least one OLED or similar seal-requiring device using a high-intensity short pulse duration laser. Usefully, the laser provides a photon flux or intensity at a rate that multi-photon absorption occurs to locally excite molecular species in the substrate or plate, thereby heating the material locally so that it bonds to another substrate creating a hermetic seal between the substrates. This process is repeated about the perimeter of the substrate to create a hermetic seal about the substrates, thereby sealing the OLEDs or similar seal-requiring devices from moisture, oxygen and other contaminants. Finally, heating the focal volume through multiphoton absorption, the intense heat causes the interface of the glass to swell and bond onto the other glass substrate, the example embodiments described herein, the OLEDs or similar devices are disposed between two layers or substrates of glass material.

In accordance with the example embodiments, the methods and apparati have at least the following characteristics, which afford particular benefits. First, the hermetic seal is comprised of a portion of a substrate of the package. This seal provides a barrier for oxygen on the order of approximately 10⁻³ cc/m² per day or less and a barrier for water penetration of on the order of approximately 10⁻⁶ g/m² per day or less. Second, the size of the hermetic seal (bonding line) is minimal, being on the order of approximately less than 2.0 mm, so it does not have a significant adverse impact on size of the OLED display. Third, the temperature generated during the sealing process does not significantly damage the materials (e.g., electrodes and organic layers) within the OLED display. For instance, the first pixels of OLEDs, which are located approximately 1.0 mm to approximately 2.0 mm from the seal in the OLED display, are not heated to more than approximately 100° C. during the sealing process. Fourth, and as will become more clear as the present description continues, the hermetic seal enables electrical connections (e.g., thin-film chromium or ITO) to enter the OLED display without being damaged by the sealing process and without compromising the hermeticity of the seal. Fifth, the gases released during sealing process do not significantly contaminate the materials within the OLED display. It is emphasized that these characteristics and benefits are merely illustrative and in no way limiting of the characteristics of the example embodiments.

As described in more detail herein, the sealing of packages of example embodiments is effected using multiphoton absorption techniques. For reasons which will be explained below, multiphoton absorption occurs when incident light intensity exceeds certain threshold (e.g., >GW/cm²). This means that multiphoton absorption can be set up at the desired physical location, in contrast with single-photon (linear) absorption where one has no control over location. Moreover, sealing methods of example embodiments may be effected in a glass substrate which is transparent to the laser wavelength in use. This can be very advantageous in display applications where transparent glass substrates are used. Finally, multiphoton absorption is also referred to as nonlinear absorption, since it involves the participation of at least two photons which are separated in incident by a short amount of time. Hence, the light intensity is relatively high by this process.

One of the applications of sealing glass packages such as OLED involves the use of two glass substrates. On one of the glass substrate, the organic materials and electrode leads are deposited. This substrate is often referred to as the bottom substrate. A portion of the other glass substrate is used to form a hermetic seal. This glass substrate, the top substrate, has the suitable properties for multiphoton absorption.

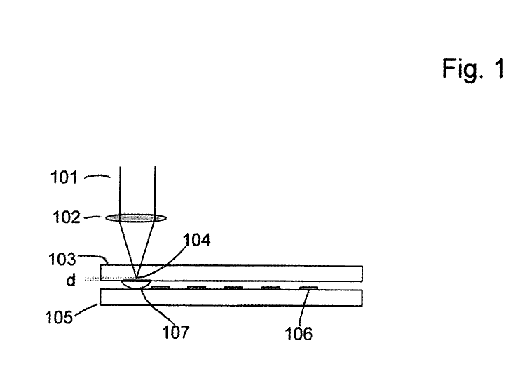

FIG. 1 shows a process of hermetically sealing an OLED display about its perimeter in cross-section and in accordance with an example embodiment. One or more of a plurality of OLEDs 106 are disposed in an array on a top surface of a bottom substrate 105. The OLEDs 106 may be disposed over or will be in contact with electrodes, which are not shown in the present view. A top substrate 103 is disposed over the bottom substrate 105 and is sealed thereto by the conversion of irradiation energy to heat in a non-radiative process of an example embodiment. In keeping with the example embodiments, the substrates 103 and 105 are glass materials that are transparent to light at the emission wavelength of laser. Illustratively, display glass such as commercially available Corning Incorporated 1737 glass or Eagle 2000 glass may be used as the substrate 105.

The top substrate 103 illustratively is a glass material which preferably, has a low softening point (preferably less than approximately 600° C.) and is transparent in the visible range. Moreover, for reasons that will be clearer as the present description continues, the top substrate 103 is of a material that has a UV absorption edge that is at or below the two-photon energy of a visible, short duration (e.g., nanosecond) laser, with suitable nonlinear properties. Most transparent silicate glass materials have an absorption edge of approximately 300 nm to approximately 400 nm, and thus could be used for the top substrate 103. Of course, this is merely illustrative, and other transparent glass materials may be used. For example, glass materials including, but not limited to soda-lime glass, phosphate glasses, chalcogenide glasses and vanadate glasses, may be used. Finally, it is noted that materials other than glass having the properties described above may be used for the substrates 103 and 105.

A pulsed laser beam 101 is focused via an optical 102 to a focal point 104, which is a distance ‘d’ from the bottom surface of the top substrate. As discussed more fully below, the element 102 may be a lens or other optical element used for focusing a light source to a relatively small spot. The pulsed laser has a duration and an intensity that results in multi-photon absorption in the material of substrate 103. This absorption results in the heating of the substrate 103. For reasons which will be described, this heating is achieved locally in an area around the focal point 104 of the laser. The swelling of the glass forms a seal with the substrate 105. To this end, the laser pulse is focused at the focal point 104 within the bulk of the material of the substrate 103.

The intensity of the irradiation from the laser within the focal volume is great enough to heat the material by nonlinear light absorption (e.g., multi-photon absorption). This results in a swelling 107 in the top substrate 103 at regions within the focal volume of the optics 102, and this swelling creates a hermetic bond between the top substrate 103 and the bottom substrate 105. Further details of the use of multi-photon absorption techniques on glass materials may be found in “Structural Changes Induced in Transparent Materials with Ultrashort Laser Pulses” to C. Schaffer, et al. Digest of Conference on Lasers and Electro Optics (CLEO) 2000 OSA Technical Digest Series, the disclosure of which is specifically incorporated herein by reference.

In accordance with the present and other example embodiments, the absorption of radiation from the laser is strongly nonlinear at high intensity (power per unit area). Most of the silicate glass materials are transparent in the visible spectral region. Moreover, the bandgap of most undoped glass materials is in the UV region (A on the order of less than approximately 400 nm). Light of visible and near infrared wavelengths will propagate through the material without substantial absorption. Thus, there is little heating of the glass upon irradiation from laser source, except in the region of the focal volume. Within the focal volume, the beam diameter is reduced and hence, the light intensity is greatly increased.

At certain intensities, absorption in the local volume due to the multiphoton process (absorption of two or more photons simultaneously) is significantly higher than that of the linear (one-photon) process. By selecting glass materials that exhibit nonlinear absorption, the absorbed laser energy is converted into heat via nonradiative energy transfer. Accordingly, as successive photons are incident within the focal volume, heat generated by multiphoton process melts (or swells) the glass (as at 107) fostering the sealing of the glass around the focal volume. By controlling the distance ‘d’ between the focal point and the substrate surface, and the pulse energy, a controlled amount of swelling occurs. In the example embodiments, the focal point experiences the greatest increase in temperature. It is noted that in the swollen region 107, the temperature is lower than at the focal point 104, and the temperature outside the swollen region is nearly unaffected by the irradiation from the laser. As light propagates through the focal volume, its intensity is reduced due to nonlinear absorption. In addition, it defocuses. As such, the electrodes and the organic material of the OLEDs 106 are substantially unaffected by the sealing process.

Certain example embodiments are drawn to a method to seal glass packages such as OLED structures using illustrative multiphoton absorption processes. A multiphoton process can occur through the absorption of two or more laser photons with the same amount of energy. Additionally, in accordance with other example embodiments, multiple photon absorption can happen through the absorption of two or more laser photons with different energies. These illustrative mutiphoton processes include the participation of two or more photons from two or more laser sources, with distinctively different emission wavelengths.

Multiphoton absorption can be formally described by multi-step processes involving intermediate virtual electronic (quantum) states. In many cases a multiphoton absorption coefficient can be enhanced when the intermediate electronic states are close to or at atomic and molecular resonances. This can be achieved by selective modification of the glass properties (e.g., doping the glass substrate). The multiphoton processes of example embodiments include the use of intermediate resonances to enhance multiphoton absorption. These illustrative methods include the use of particular dopants to increase multiphoton absorption coefficient.

Illustratively, the optics 102 is a positive lens, microscope objective or other suitable optical element, which beneficially focuses the radiation source near diffraction limit at the focal point 104. This tight focusing is beneficial to ensure that the sealing occurs within relatively tight tolerances. Moreover, the tight focusing of the example embodiments ensures that the display surface is substantially not altered, and the electrodes and organic material of the OLED's 106 are essentially not damaged by the sealing process. Rather, heating occurs only in the region where sealing is desired. The lens or microscope objective 102 should be well compensated for aberrations or self-focusing effects, or both. As an illustration, a focal diameter of approximately 10 μm is useful in the current application in order to effect adequate bonding between the glass substrates.

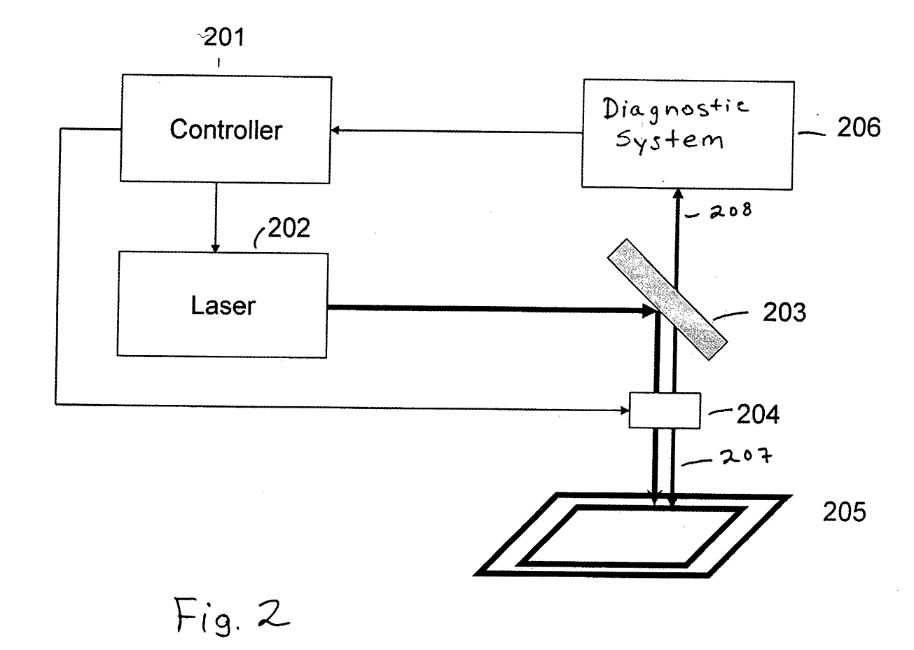

FIG. 2 illustrates a configuration of an apparatus 200 for sealing top and bottom substrates of an OLED structure in accordance with an example embodiment. Many of the details described in connection with the example embodiment of FIG. 1 apply to the present embodiment, and such commonalities are not duplicated so as to not obscure the description of the present embodiments.

The apparatus 200 includes a controller 201 and a laser 202. A turning mirror 203, which reflects nearly 100% of the laser light is disposed between the laser 202 and a substrate (e.g. the top substrate 103) 205 as shown. An optical element 204 is disposed between the turning mirror 203 and provides focusing of the light from the laser onto the glass substrate 205, which is illustratively the top glass substrate of the OLED structure.

A diagnostic system 206 is useful in providing real-time monitoring of the sealing process. The system 206 illustratively provides a distance feedback measurement information and information of the laser energy. The distance feedback information is determined using a visible light source or a probe laser (neither shown) operating at a different wavelength than laser 202. A probe beam 207 from the diagnostic system 206 passes through turning mirror 203. Reflections 208 from glass package or OLED are detected by the distance feedback system 204, and the information on the position of the glass package is fed to controller 201. Alternatively, other types of position sensitive feedback system can also be used.

The laser energy/power information during operation is typically obtained through light emissions from the focal volume. The controller 201, typically a computer with peripheral data acquisition systems, receives and processes information from the diagnostics system 206. It is noted that the optical focusing element 204 is mounted on a vertical translation stage (not shown).

The controller 201 usefully provides suitable controls for laser 202 and focusing element 204. The laser 202 is a pulsed laser having a relatively short duration. Illustratively, the laser 202 may be a commercially available high-repetition rate frequency-doubled diode-pumped solid state (DPSS) laser having a wavelength of approximately 532 nm or a femtosecond laser having a wavelength in the range of approximately 800 nm. The laser beam of choice will experience little absorption while propagating through glass substrate 205 at low intensity.

However, and as described above, at higher power levels, multi-photon absorption occurs in the normally transparent regions of the glass substrate 205 where the radiation source is focused by the optical element 204. To this end, multi-photon absorption is the dominant action of the laser at laser powers above a required threshold power. In keeping with the present example embodiments, the laser 202 provides a power per unit area in the range of approximately 1.0 GW/cm² to approximately tens of thousands (10⁵) of GW/cm², depending on the multiphoton coefficient of the glass substrate 205 being used. Illustratively, the pulse duration is on the order of ten nanoseconds for a given focal diameter of approximately 10.0 μm As such, the energy to achieve the requisite power per unit area is on the order of approximately 10.0 μJ to approximately 100.0 mJ. It is noted that in the example embodiments, the pulse duration may be on the order of approximately picoseconds to approximately femtoseconds, provided the laser intensity is lowered commensurately so that the power per unit area is within the range referenced above.

In operation, the laser continuously seals about the perimeter of the substrate 205 by effecting multiphoton absorption. To wit, the substrate 205 is disposed over a translation device (not shown) that provides precise movement of the substrate 205 so the sealing may be effected about the perimeter.

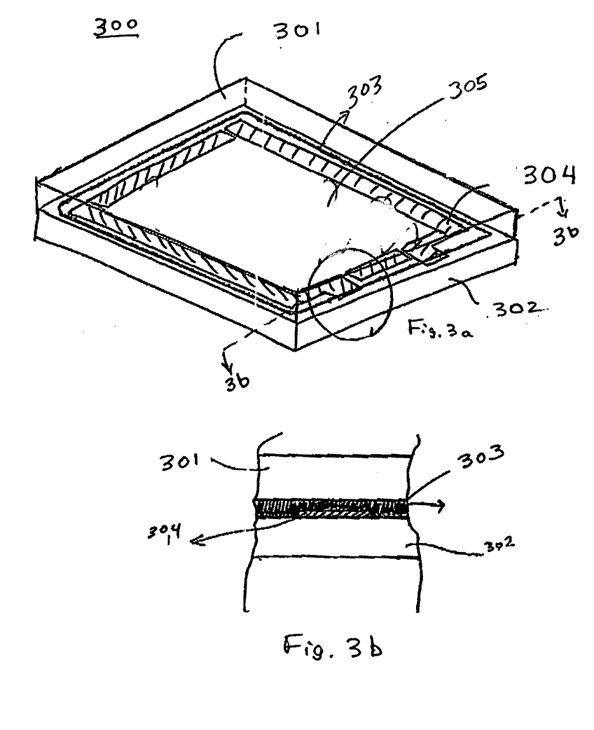

FIGS. 3a and 3b show a sealed OLED array in accordance with an example embodiment. A sealed OLED structure 300 includes a top substrate 301, a bottom substrate 302, and a sealing line 303 about the perimeter of the structure. OLED material 305 is disposed between the top and bottom substrates 301 and 302, and is sealed from the surrounding environment by the sealing line 303, which is fabricated in a manner that is described previously.

In addition, the necessary and customary electrical connections to the OLED material 305 are effected by electrodes 304, which may be Indium-Tin Oxide (ITO), or other suitable material used to effect electrical connections to OLED materials and devices. Beneficially, the electrodes 304 are fabricated from a material that is not susceptible to melting or degradation by the heat generated in the sealing process. Accordingly, materials such as ITO and other materials commonly used for electrodes in optoelectronic and semiconductor (IC) processing may be used. It is clear that such materials will be readily apparent to one having ordinary skill in the art having had the benefit of the present disclosure.

In an example embodiment, the structure 300 has a bottom substrate 302 that is slightly larger in at least one area than the top substrate. This allows some of the electrodes 304 on the bottom substrate 302 to be exposed to ambient environment to facilitate connections thereto. Clearly, one useful aspect of the example embodiments is the ability to have electrical connections (electrodes) between the sealed OLED devices and the outside environment without compromising the integrity of the package. The example embodiment of FIG. 3b, which is a partial cross-sectional view along the line 3b-3b illustrates this useful aspect. In this example embodiment, the sealing (or swollen) portion of the top substrate 302 forms the sealing line 303 about the electrode 304 without damaging the electrode. By forming the seal around the electrode 304, the hermeticity of the seal between the top substrate and the bottom substrate 302 is maintained via the example embodiments.

The methods described above in connection with example embodiments include the use of multiphoton absorption to back-seal an OLED device or array. As described, when the laser is focused within the bulk glass, the intensity of irradiation in the focal volume is usefully great enough to heat the material by non-linear absorption process such as multi-photon absorption at wavelengths at the absorption edge of the material.

Typically the two-photon coefficient is significantly higher than three- or four-photon absorption process. Quantitatively, a two-photon absorption (TPA) technique is presently described, although other example embodiments could incorporate three or more photon absorption events to realize the desired sealing of the substrates of an OLED display structure. For a TPA process, the absorption is directly proportional to the square of the intensity of the incident light, I. For a pulsed laser with a rectangular impulse, having a pulse energy, E, and an intensity that is distributed uniformly in a circular area having a radius, r, the TPA is:
TPA=C[E*(τπr²)⁻¹]²
where τ is the pulse period and C is a constant of proportionality. In most cases C is two-photon absorption coefficient of the glass substrate 205. From this equation it is clear that the TPA is proportional to (1/r⁴), implying that TPA is localized in a region about the focal point. Of course, this is beneficial in localizing the sealing and in preventing damage to electrodes and alteration of the display area.

The example embodiments having been described in detail in connection through a discussion of exemplary embodiments, it is clear that modifications of the invention will be apparent to one having ordinary skill in the art having had the benefit of the present disclosure. Such modifications and variations are included in the scope of the appended claims.

1. A method of sealing, the method comprising:
providing a top substrate and a bottom substrate, and at least one layer of organic material between the substrates; and
focusing a relatively high power, short-duration laser irradiation onto a region of the top glass substrate, thereby sealing the top substrate to the bottom substrate.

2. A method as recited in claim 1, wherein at least one of the substrates is glass.

3. A method as recited in claim 1, wherein the focusing effects a localized non-linear optical absorption of the light.

4. A method as recited in claim 3, wherein the non-linear optical absorption is a multiphoton absorption.

5. A method of as recited in claim 2, wherein at least one of the substrates absorbs substantially none of the light from the laser wavelength at low intensities.

6. A method as recited in claim 1, wherein one of the substrates does not have electrodes.

7. A method as recited in claim 2, wherein a bandgap of the at least one glass substrates lies in the UV range.

8. A method as recited in claim 7, wherein the top glass substrate absorbs energy through non-radiative process.

9. A method as recited in claim 8, wherein the top glass substrate efficiently transfers energy from the laser to heat through non-radiative process.

10. A method as recited in claim 1, wherein an OLED material is between the two glass substrates.

11. An apparatus for sealing, comprising:
a laser;
a controller, which controls the output power of the laser; and
an optical element that focuses light from the laser onto a top substrate, wherein the substrate absorbs the light in a multiphoton absorption process, providing a hermetic seal between the top substrate and a lower substrate.

12. An apparatus as recited in claim 11, wherein the laser emits light at a wavelength that corresponds to an energy that is less than a bandgap energy of a material of the top layer.

13. An apparatus as recited in claim 11, wherein the focusing of the light by the optical element provides an intensity within a focal volume of the optical element that exceeds a threshold for multiphoton absorption.

14. An apparatus as recited in claim 11, wherein the laser emits light at a wavelength that corresponds to an energy that is less than a bandgap energy of a material of the top layer.

14. An apparatus as recited in claim 11, further comprising:
a diagnostic system, which provides monitoring of a sealing process.

15. An apparatus as recited in claim 14, wherein the diagnostic system 206 provides distance feedback measurement information.

16. An apparatus as recited in claim 14, wherein the diagnostic system 206 provides laser energy data.

17. An apparatus as recited in claim 14, further comprising an optical element that reflects light from the laser, and which transmits light from a probe beam from the diagnostic system.

18. An apparatus as recited in claim 17, wherein the probe beam is emitted from a light source of the diagnostic system.

19. An apparatus as recited in claim 11, wherein the bottom substrate and the top substrate are glass, and an OLED material is disposed over the bottom substrate.

20. An OLED package, comprising:
a top substrate and a bottom substrate; and a
a glass hermetic seal between the substrates, which provides a barrier to contaminants.
